(19) United States
(12) Patent Application Publication
(10) Pub. No.: US 2002/0124955 A1
(43) Pub. Date: Sep. 12, 2002

(54) Attachment of a heat spreader for fabricating a cavity down plastic chip carrier

(76) Inventors: I-Chung Tung, Hsinchu (TW); Shih-Ping Hsu, Tao Yuan (TW)

Correspondence Address: Raymond Sun, 12420 Woodhall Way, Tustin, CA, 92782, US

(21) Appl. No.: 09/802,306

(22) Filed: Mar. 8, 2001

(51) Int. Cl. B32B 31/00

(52) U.S. Cl. 156/300; 156/327; 156/324.4

(57) ABSTRACT

A heat spreader attachment method for making a cavity down plastic chip carrier devoid of warpage and twist is disclosed. A bonding sheet is used to bond a circuit substrate and a heat spreader. The bonding sheet is made of a single adhesive layer or a stacking of more adhesive layers. The adhesive layer is made of an adhesive material, or a flake-filled adhesive material, or fiber-filled adhesive material, or a particle-filled adhesive material. The circuit substrate possesses an opening to receive an electrionic chip.

### BACKGROUND OF THE INVENTION

1. Field of Invention

This invention relates generally to fabrication of the electronic packages, including single-chip packages and multichip packages, and in particular, to fabrication of a plurality of cavity down electronic chip packages having heat spreaders attached thereto.

2. Description of the Related Art

With continuing advances in the semiconductor industry, electronic circuitry and electronic packaging are often designed to utilize as little space as is practicable. Circuit space often is a valuable asset which needs to be conversed, and a miniaturization of electronic circuits often improves speed, reduces noise and leads to other performance advantages. Such a miniaturization is desirable in electronics employed in various applications, such as aircraft, automobiles, cellular phones, hand carry computers, hand carry camcorders, etc. However, heat density problems often arise with increased miniaturization, since the amount of heat generated by the device increases as the number of transistors fabricated onto a single semiconductor device increases.

One type of semiconductor chip package includes one or more semiconductor chips attached to a substrate, e.g. a ceramic substrate or a plastic substrate, wherein a ceramic substrate uses ceramic material as the insulating layers while a plastic substrate uses a plastics-based material as the insulating layers. Such a semiconductor chip package, conventionally termed a chip carrier, is generally interconnected on a printed circuit card or printed circuit board. Chips can be attached to the substrate in several ways. Currently, the most popular way is wire bonding, in which electrical connections are made by attaching very small wires from the device side of the chip to the appropriate points on the substrate. Another way of attachment uses small solder balls to both physically attach the chip and make required electrical connections, which is so called flip chip bonding.

It has been a long period of time in the packaging industry since assorted methods were employed to mount various integrated circuit chips in plastic packages for a lower cost packaging means as compared with ceramic packages. The plastic packages have also long been recognized to provide several important advantages for the chip operation as compared with ceramic packages, including higher current carrying capacity, lower dielectric constant for short operational delay times, along with reduced inductance and capacitance. However, currently low temperature stability experienced with plastic packages still remains as a problem. This issue has gained much attention in the development of modern plastic packages. One solution to this issue is to adopt a cavity down chip package structure, in which a heat slug or a heat spreader is attached to the bottom of the package and the chip is mounted in a recess cavity with its open side facing toward the printed circuit card or printed circuit board.

The typical prior art cavity down plastic chip packaging assemblies are shown in FIGS. 1 and 2. Referring to FIG. 1, the packaging assembly 100 includes a plastic wiring substrate 101 with a recess cavity 102 and a heat slug or heat spreader 103 bonded to the substrate 101 with assistance of a bonding layer 104. A side-wall electrically and/or thermally conductive layer 105 may be made to connect the heat spreader with the wiring layer in said substrate 101 for further enhanced thermal or electrical performance. A chip 106 is mounted on the heat spreader 103 inside the recess cavity 102. Conductive wires 107 are used to interconnect the chip 106 to the substrate 101. After the wire bonding process, the cavity 102 is filled up with an encapsulant 108 to cover and protect the bonding wires 107 and chip 106 against environmental degradation. The external connection means 109, by which the substrate 101 is electrically connected to a printed circuit board 110, are attached to appropriate areas on the top surface of the substrate 101. The external connection means 109 may be conductive pins or solder balls or columns as utilized in plastic pin grid array (PPGA) or plastic ball grid array (PBGA) or plastic column grid array (PCGA) package. Another example of the prior art cavity down plastic chip carriers is shown in FIG. 2, in which the packaging assembly 200 includes a plastic wiring substrate 201 with a recess cavity 202 and a heat slug or heat spreader 203 is bonded to the substrate 201 with assistance of a bonding layer 204. A chip 205 is mounted on the substrate 201 inside the recess cavity 202 by the solder balls 206. The area beneath the semiconductor chip 205 is covered for protection by an underfill resin, which serves as an encapsulant for the sensitive electrical connections. The remaining space of the cavity above the chip 205 is filled up with a glop top resin 207, preferably having high conductivity, for covering and protecting the chip 205 from environmental degradation. As an alternative structure, an additional heat slug may be attached to the backside of the chip 205 if necessary. The external connection means 208, by which the substrate 201 is electrically connected to a printed circuit board 209, are attached to appropriate areas on the top surface of the substrate 201. The external connection means 208 may be conductive pins or solder balls or columns as utilized in plastic pin grid array or plastic ball grid array or plastic column grid array. It is to be noted that an additional heat sink may be directly attached to the heat spreader 103 or 203 in the assembly 100 or 200 for further enhancing heat dissipation.

A prior proposal in relation to cavity down plastic chip carries can be found in the U.S. Pat. No. 4,420,364 (T. Nukii et al). Said patent provides a method of attaching a metallic heat spreader to a multiplayer circuit board having an opening for receiving a high power semiconductor chip, in which the heat spreader may be linearly co-extensive with the multiplayer circuit board. However, this prior attachment method shows quite complex, wherein the conductive and insulating layers stacked alternatively are directly formed on the metallic heat spreader. Another prior proposal in relation to cavity down chip carriers can be found in the U.S. Pat. No. 5,027,191 (R. A. Bourdlaise et al). This patent already shows a clear design of a multi-tier circuit substrate with an opening to receive a semiconductor chip but does not specify any attachment method of a heat spreader to the circuit board for forming a cavity down chip carrier. In another U.S. Pat. No. 5,130,889 (W. R. Hamburgen et al), a method of filling the cavity with a liquid encapsulant in forming a cavity down plastic chip carrier is disclosed. The method greatly improves the reliability of a cavity down plastic chip carrier.

A cavity down plastic chip carrier with a rather easy manufacturing method is disclosed in the U.S. Pat. No. 5,357,672 (K. G. Nowman). The method involves the use of a prepreg as a bonding layer. By using pressure and heat, a heat spreader and several unit circuit board are bonded together with assistance of the bonding layers; in turn, based on the wiring bond technique, a cavity down plastic carrier is thus constructed. Following this method, the formation of the circuit board having an opening to receive a semiconductor chip and the attachment of the heat spreader to the circuit board are accomplished at the same time. Also, the heat spreader is better to be linearly co-extensive to the circuit board due to the requirement of flatness in the heat-pressing process. However, according to the practical experiences, the chip carrier made by such an easy method is often prone to warp and twist due to cure shrinkage of the prepregs in the heat pressing process.

U.S. Pat. No. 5,583,378 (R. C. Marrs et al) also provides a method for making a cavity down plastic chip carrier. This patent teaches the use of an adhesive as the bonding layer but without specifying any particular adhesive. The patent Claims that the heat spreader with the thickness less than 1 millimeter is made by copper or aluminum, on the surface of which a black oxide layer is formed to enhance the adhesive strength. However, according to the practical experiences, to decrease warpage and twist of a cavity down plastic chip carrier is a critical task, specially in making a fine pitch chip carrier. Under such a consideration, not all kinds of adhesives are suitable to act as the bonding layer.

### SUMMARY OF INVENTION

It is therefore an objective of the present invention to provide a heat spreader attachment method for making a cavity down plastic chip carrier devoid of warpage and twist.

Another objective of this invention is to adopt a bonding sheet for bonding a circuit substrate and a heat spreader. The bonding sheet with any configuration is made of a single adhesive layer or a stacking of more adhesive layers. The adhesive layer is made of an adhesive material, a flake-filled adhesive material, a fiber-filled material, or a particle-filled material. The adhesive layer is not a prepreg. The coefficient of thermal expansion (CTE) of the hardened bonding sheet is less than 200 pm/° C. The circuit substrate possesses an opening to receive an electronic chip.

A further objective of the present invention is the provision of the heat spreader, which is a copper sheet with a thickness larger than 0.254 millimeter or a copper base alloy sheet with a thickness larger than 0.1 millimeter. For the copper sheet, the content of the alloy elements added is less than 0.1 weight percent of the total weight of the copper sheet. For the copper base alloy sheet, the content of the alloy elements added is less than 5 weight percent of the total weight of the copper base alloy sheet.

In summary, according to the present invention, a heat spreader attachment method for making a cavity down plastic chip carrier devoid of warpage and twist is disclosed wherein a bonding sheet is used to bond a circuit substrate and a heat spreader. The bonding sheet is made of a single adhesive layer or a stacking of more adhesive layers. The adhesive layer is made of an adhesive material, or a flake-filled adhesive material, or fiber-filled adhesive material, or a particle-filled adhesive material. The circuit substrate possesses an opening to receive an electronic chip.

### BRIEF DESCRIPTION OF THE DRAWINGS

FIG. 1 is a cross-sectional view of a prior art cavity down chip carrier based on wiring bond techniques.

FIG. 2 is a cross-sectional view of a prior art cavity down chip carrier based on flip chip technique.

FIG. 3 is an exploded view showing the layers used to construct a wiring-bond based cavity down chip carrier in accordance with one embodiment of the present invention

FIG. 4 is an exploded view showing the layers used to construct a flip-chip based cavity down chip carrier in accordance with one embodiment of the present invention

FIG. 5 is a top view showing the passives mounted on the surface of a cavity down chip carrier through the heat spreader

FIG. 6 is an exploded view showing the layers to construct a multichip cavity down chip carrier.

### DETAILED DESCRIPTION OF A PREFERRED EMBODIMENT

For a better understanding on the advantages and capabilities of the present invention, reference is made to the following disclosure, appended Claims in connection with the accompanying drawings. This invention, however, is embodied in many different forms and should not be construed as limited to the embodiments set forth herein. Rather, these embodiments are provided so that this disclosure will be thorough and complete, and will fully convey the scope of the invention to those skilled in the art.

The invention provides a heat spreader attachment method for making a cavity down chip carrier devoid of warpage and twist. At the same time the efficiency of heat dissipation can still be maintained. The method is detailed as follows. However, the figures are simply illustrative of the process, and are not drawn to scale, i.e. they do not reflect the actual dimensions or features of the various layers in the chip carrier structure.

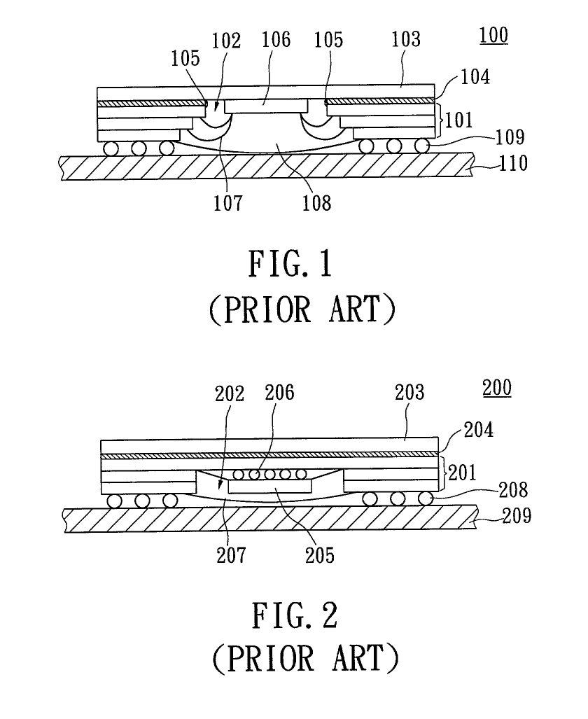

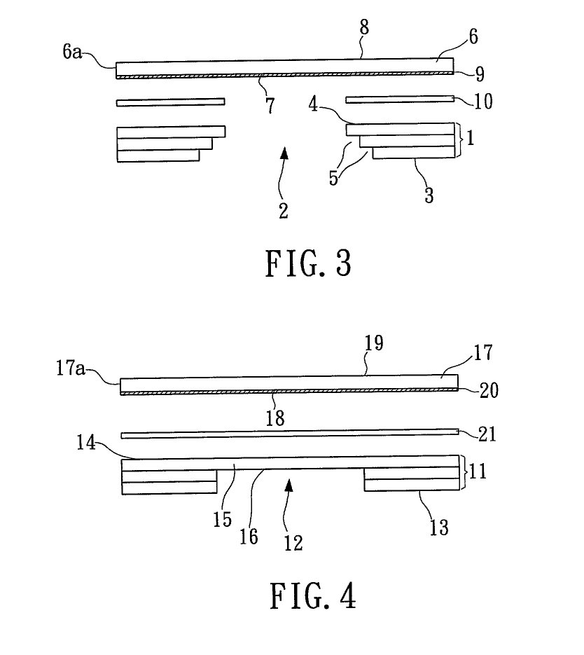

Now referring to FIG. 3, in accordance with a preferred embodiment of the present invention, there is initially provided a plastic chip carrier substrate 1 with an opening 2, a first surface 3, a second surface 4 opposite to said first surface 3 and several tiers 5. Said substrate 1 may have wiring circuit layers separated by organic insulating layers, through-holes, conductive through-holes, vias in said substrate 1, electrodes (or say bond fingers) and protective layers on the surfaces of said tiers 5, electrodes (or say landing pads), dam, and protective coating on surface 3, and electrodes and protective coating on said second surface 4, all of which are well-known techniques in the art. A thermally conductive sheet 6 (or say heat spreader), preferably a copper or copper base alloy sheet, a conductive particle-filled copper or copper alloy sheet, or a conductive fiber-filled aluminum or aluminum alloy sheet, may be surface roughened chemically or physically on both surfaces, i.e. the first surface 7 and second surface 8. On said first surface 7, an adhesion promoter 9, e.g. an oxide layer or a coupling agent layer, preferably a brown oxide layer is deposed to enhance adhesion property. A coupling agent may comprise silane coupling agent, titanium coupling agent, zirconium coupling agent, or aluminum coupling, etc. However, according to this present invention, said adhesion promoter is not limited to an oxide or a coupling agent. On said second surface 8, a protective coating, e.g. nickel, gold, thermally conductive particle-filled epoxy resin, diamond, or diamond like carbon, etc., may be formed. However, said second surface 8 may be surface roughened chemically or physically before the deposition of said protective coating. A bonding sheet 10 is placed in between said bottom surface 5 of said substrate 1 and said first surface 7 of said heat spreader 6. By pressing, said heat spreader 6 are bonded to said bottom surface 5 of said substrate 1 after said bonding sheet 10 is hardened by a means, such as heat or radiation, etc. After side-wall plating, die attachment, wire bonding, encapsulant filling, and external terminal attachment processes, which are well-known techniques in the art, are finished, a cavity down chip carrier 100 shown in FIG. 1 can thus be constructed.

Referring next to FIG. 4, in accordance with a preferred embodiment of the present invention, there is initially provided a plastic chip carrier substrate 11 with an opening 12, having a first surface 13 and a second surface 14 opposite to said first surface 13. Said substrate 11 may have wiring circuit layers separated by organic insulating layers, through-holes, conductive through holes, vias in said substrate 11, electrodes (or say landing pads), dam, and protective coating on said first surface 13, and electrodes and protective coating on said second surface 14, all of which are well-known techniques in the art. It is to be noted that said opening 12 does not penetrate through said substrate 11 but there remains a semiconductor die bonding portion 15 at the bottom of said opening 12. Electrodes are also made on the surface 16 of said die bonding portion for mounting a semiconductor die in a flip-chip configuration. A thermally conductive sheet 17 (or say heat spreader), preferably a copper or copper base alloy sheet, a conductive particle-filled aluminum or aluminum alloy sheet, or a conductive fiber-filled copper or copper alloy sheet, may be surface roughened chemically or physically on both surfaces, i.e. the first surface 18 and second surface 19. On said first surface 18, an adhesion promoter 20, e.g. an oxide layer or a coupling agent layer, preferably a brown oxide layer is deposed to enhance adhesion property. A coupling agent may comprise silane coupling agent, titanium coupling agent, zirconium coupling agent, or aluminum coupling, etc. However, according to this present invention, said adhesion promoter is not limited to an oxide or a coupling agent. On said second surface 19, a protective coating, e.g. nickel, gold, thermally conductive particle-filled epoxy resin, diamond, or diamond like carbon, etc., may be formed. However, said second surface 8 may be surface roughened chemically or physically before the deposition of said protective coating. A bonding sheet 21 is placed in between said second surface 14 of said substrate 11 and said first surface 18 of said heat spreader 17. By pressing, said heat spreader 18 is bonded to said second surface 14 of said substrate 11 after said bonding sheet 21 is hardened by a means, such as heat or radiation, etc. After die solder-bump attachment, encapsulant filling, external terminal attachment processes, which are well-known techniques in the art, are finished, a cavity down chip carrier 200 shown in FIG. 2 can thus be constructed. In this resultant chip carrier, the chip mounted indeed is not directly in contact with said heat spreader 17. Under such a condition, therefore a plurality of thermal vias are necessarily made in said die bonding portion 15 of said substrate 11, whereby those thermal vias serve as the heat channels between said mounted chip and said heat spreader 17. It is desirable that those thermal vias are also electrically conductive, so that said heat spreader 17 can further participate and serve as ground reference when the ground terminals on said mounted chip are intentionally connected to said thermal vias. In such a case, the resultant chip carrier could then offer more stable ground reference and thus give the output signals with lower noise, which is much beneficial especially for portable electronic products.

Said plastic chip carrier substrate 1 or 11 may be a single-layer or multilayer substrate having a plurality of overlapping alternating layers of dielectric material (i.e. for forming insulating layer) and conductive material, wherein said organic dielectric material is an organic material or a fiber-reinforced organic material or a particle-reinforced organic material, for example, epoxy resin, polyimide, bismeleimide triazine, cyanate ester, polybenzocyclobutene, or glass fiber composite thereof. Said plastic chip carrier substrate 1 or 11 is preferably formed before bonded to said heat spreader 6 or 17, so that said conductive through-holes completely penetrating through said substrate 1 or 11 can be made for forming a cavity down chip carrier 100 or 200. Besides, cure shrinkage occurring during the formation of said substrate 1 or 11 will not be able to induce any warparge or twist while said substrate 1 or 11 is bonded to said heat spreader 6 or 17.

When said heat spreader 6 or 17 is made of copper or copper base alloy, it is known in the practical operation that a copper sheet may become soft when the operating temperature approaches about 300-400° C. According to the current technologies, if said heat spreader 6 or 17 made of copper is too thin, e.g. less than 0.5 millimeters, it becomes very difficult to handle said heat spreader 6 or 17 during the manufacturing process of said plastic chip carrier 100 or 200 due to easy deformation of said heat spreader 6 or 17. It is therefore that the thickness of said heat spreader 6 or 17 made of copper is preferably larger than 0.5 millimeters. However, when the thinner heat spreader 6 or 17 is needed, i.e. less than 0.5 millimeter, a copper base alloy used to form said heat spreader 6 or 17 which has a higher mechanical strength is preferred. The content of the alloy elements of said copper base alloy is better less than 5 wt % (weight percent of the total weight of said copper base alloy), e.g. C194 or C305 copper alloy, preferably less than 0.5 wt %, e.g. C151 copper alloy, since a higher content of added alloy elements would give a lower thermal conductivity of said copper base alloy. It is to be noted here that copper in the present invention means a copper alloy with a content of the alloy elements less than 0.1 wt %. However, when the further thinner heat spreader 6 or 17, e.g. less than 0.25 millimeter, said heat spreader 6 or 17 should have a higher thermal conductivity and a higher mechanical strength than those of a copper or copper base alloy must be chosed, such as a graphite fiber-filled copper, silicon carbide particle-filled copper, graphite fiber-reinforced aluminum, or silicon carbide particle-filled aluminum.

In order to protect said heat spreader more fully from environmental corrosion, the side walls 6a and 17a of said heat spreaders 6 and 17 may also be coated with a protective layer, e.g. nickel, gold, thermally conductive particle-filled epoxy resin, diamond, or diamond like carbon, etc., may be formed. When such a protective layer is deposited on said side wall 6a or 17a, the thermal dissipation is enhanced at the same time, since the surface area for heat dissipating is increased.

Said bonding sheet 10 or 21 is made of an adhesive layer or a stack of several adhesive layers. Said adhesive layer is made of an adhesive material, short fiber-filled adhesive material, flake-filled adhesive material, or particle-filled adhesive material. Since woven fibers are not filled in said adhesive material, said adhesive layer will not be a prepreg in the present invention. Examples of said adhesive material can be a resin, e.g. epoxy resin, polyimide resin, polyurethane, and acrylic resin, etc., a copolymer, e.g. epoxy-acrylic resin, epoxy-butadiene resin, and epoxy-urethane resin, etc., a polymer blend, e.g. epoxy resin/halogenated polyhydroxystyrene blend, and epoxy resin resin/phenolic resin blend, etc. Said organic material can be modified by halogen silicone, or phosphite, etc. Short fibers, made of metal, organic or inorganic material, such as tungsten short fibers, aramid short fibers, glass short fibers, etc., can be filled in said organic materials for enhancing mechanical strength or reducing thermal coefficient of expansion (CTE) of said adhesive layer. Flakes or particles can also be filled in said organic material for the same purpose. Examples of flakes may be silver flakes or graphite flakes, while examples of particles may be silica particles, barium sulfate particles, clay, calcium carbonate particles, milamine particles, polystyrene particles, copper particles, or silver particles, etc. Said adhesive material may also contain some other additives, such as chemical catalysts, antioxidants, rheological agents, coupling agents, and color agents.

The selection of adhesive material for forming said adhesive layer is essential for reducing warpage and twist of a cavity down chip carrier fabricated. In the toda's industrial activity, said adhesive material made on the basis of a thermosetting resin has been the main stream. Said typical thermosetting resin is usually hardened at an elevated temperature and cooled down to room temperature. Therefore, it is preferable that said adhesive material be sufficiently soft (i.e. with low mechanical modulus) to compensate cure shrinkage occurring at the curing stage. Normally, partially curing said thermosetting resin before bonding and lowering down CTE and mechanical modulus of said adhesive material are helpful for good bonding without warping. According to our practical experience, a prepreg with a high mechanical modulus, per se, is difficult to obtain good bonding for a cavity down chip carrier. For achieving good bonding, whether too high filler loading to give a higher mechanical modulus or too low filler loading to give a high CTE should be avoided. Besides, the CTE of said adhesive layer is preferably lower than 150 ppm/° C., more preferably lower than 100 ppm/° C., most preferably lower than 50 ppm/° C. The lower CTE of said adhesive layer approaching the CTE of said heat spreader or circuit board together with the lower mechanical modulus of said adhesive layer normally further gives the better reliability of the fabricated chip carrier. In the current industrial development stage, an adhesive layer, a commercial product APAS 1592 made by Sumitomo 3M Ltd., Japan, has been densely tried. However, since APAS 1592 has a CTE of 200 ppm/° C., it seems rather difficult to make a cavity down chip carrier without warping. The other currently commercial product, R/flex® 1500 made by Rogers Corp., Chandler, Ariz., having a CTE of 600 ppm/° C., also gives a similar warpage challenge.

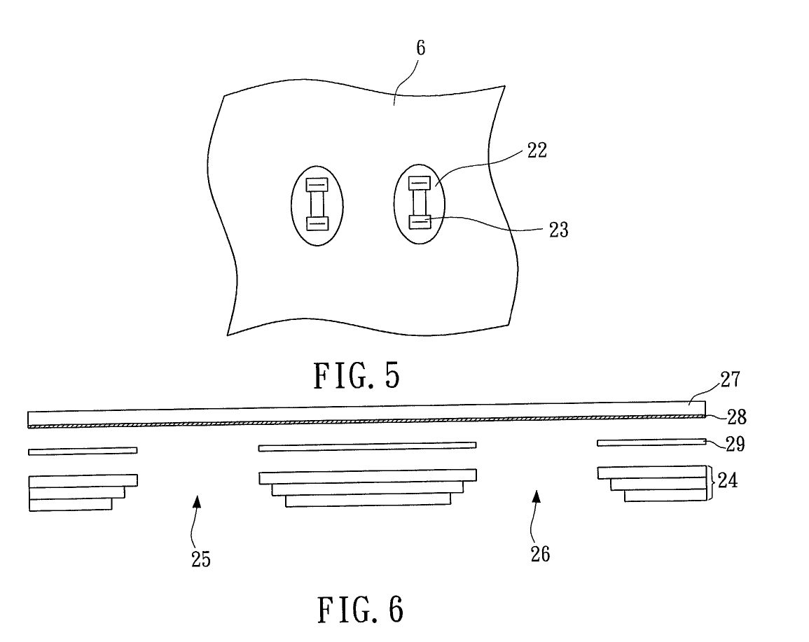

In accordance with a preferred embodiment of the present invention, said bonding sheet 10 or 21 is not limited to any shape or configuration. In order to mount passive components on said second surfaces 4 and 14 of said circuit substrates 1 and 11, the openings 22 may be made, where both the beat spreader material (i.e. copper or copper base alloy) and the adhesive material are removed, see the illustration in FIG. 5, which is the top view of said heat spreader 6 or 17. Said openings 22 may be of any shape such as, for example, round, elliptical, square, and rectangular, etc. The passive components 23 are then mounted in the openings 22. Certainly, the side walls along the edges of the holes may also be protected against environmental corrosion by depositing a protective layer thereon, e.g. nickel, gold, thermally conductive particle-filled epoxy resin, diamond, diamond like carbon, etc.

In accordance with a preferred embodiment of the present invention, said chip carrier is not limited to a single-chip package but also includes multichip package. A typical example of multichip packages is shown in FIG. 6. A circuit substrate 24 has two openings 25 and 26, each of which is able to receive a semiconductor chip. Using pressure and heat, a heat spreader 27 with an oxide layer 28 is attached to said circuit substrate 24 with assistance of a bonding sheet 29, which finally can be used to fabricate a two-chip chip carrier.

In accordance with a preferred embodiment of the present invention, said chip carriers may be made by attaching a heat spreader panel to a circuit substrate panel with assistance of a bonding sheet for industrial mass production. Said panels may be of any shape or configuration, e.g. strips, etc. However, in such a case, a careful selection of said bonding sheet will become more stringent, since a large size circuit substrate panel naturally magnifies warpage problem.

In accordance with a preferred embodiment of the present invention, said chip carrier is not only limited to receive semiconductor chip but can also receive some other chip types of electronic, optical or optoelectronic devices, such as filters, oscillators, sensors, laser diode, and vertical-cavity surface-emitting laser, etc.

While novel features of the present invention have been described with reference to one or more particular embodiments herein, those skilled in the art will recognize that many modifications and variations of the present invention are possible. Therefore, the scope of the present invention is to be limited only by the following claims.

1. A method of attaching a heat spreader to a circuit substrate for making a cavity down plastic chip carrier, comprising:
a plastic circuit substrate having a first surface and a second surface opposite said first surface, and at least an opening penetrating through said circuit substrate adapted to receive a chip;
a heat spreader having a first surface, and a second surface opposite said first surface;
a bonding sheet, which is not a prepreg, bonding said first surface of said heat spreader to said second surface of said circuit substrate;
said bonding sheet having a coefficient of thermal expansion less than 200 ppm/° C.;
said heat spreader is linearly co-extensively with said circuit substrate.

2. The method of claim 1, wherein said heat spreader is made by a material selected from the group consisting of copper, aluminum, copper alloy, aluminum alloy, particle-filled copper, fiber-filled copper, particle-filled aluminum, fiber-filled aluminum, particle-filled aluminum alloy, or fiber-filled aluminum alloy.

3. The method of claim 1, wherein said bonding sheet is made of a single adhesive layer.

4. The method of claim 1, wherein said bonding sheet is made of a stack of several adhesive layers.

5. The method of claim 3, wherein said adhesive layer is made of an adhesive material which is devoid of woven organic fibers and woven inorganic fibers.

6. The method of claim 4, wherein said adhesive layer is made of an adhesive material which is devoid of woven organic fibers and woven inorganic fibers.

7. The method of claim 3, wherein said adhesive layer is made of a short fiber-filled adhesive material.

8. The method of claim 4, wherein said adhesive layer is made of a short fiber-filled adhesive material.

9. The method of claim 3, wherein said adhesive layer is made of a flake-filled adhesive material.

10. The method of claim 4, wherein said adhesive layer is made of a flake-filled adhesive material.

11. The method of claim 3, wherein said adhesive layer is made of a particle-filled adhesive material.

12. The method of claim 4, wherein said adhesive layer is made of a particle-filled adhesive material.

13. The method of claim 1, wherein said bonding sheet is thermally conductive.

14. The method of claim 1, wherein said bonding sheet is electrically conductive.

15. A method of attaching a heat spreader to a circuit substrate for making a cavity down chip carrier, comprising:
a plastic circuit substrate having a first surface and a second surface opposite said first surface, and at least an opening said circuit substrate adapted to receive a chip;
each said opening having only one open side toward said second surface of said circuit substrate;
a heat spreader having a first surface and a second surface opposite said first surface;
a bonding sheet, which is not a prepreg, bonding said first surface of said heat spreader to said second surface of said circuit substrate;
said bonding sheet having a coefficient of thermal expansion less than 200 ppm/° C.;
said heat spreader is linearly co-extensively with said circuit substrate.

16. The method of claim 15, wherein said heat spreader is made by a material selected from the group consisting of copper, aluminum, copper alloy, aluminum alloy, particle-filled copper, fiber-filled copper, particle-filled aluminum, fiber-filled aluminum, particle-filled aluminum alloy, or fiber-filled aluminum alloy.

17. The method of claim 15, wherein said bonding sheet is made of a single adhesive layer.

18. The method of claim 15, wherein said bonding sheet is made of a stack of several adhesive layers.

19. The method of claim 17, wherein said adhesive layer is made of an adhesive material which is devoid of woven organic fibers and woven inorganic fibers.

20. The method of claim 18, wherein said adhesive layer is made of an adhesive material which is devoid of woven organic fibers and woven inorganic fibers.

21. The method of claim 17, wherein said adhesive layer is made of a short fiber-filled adhesive material.

22. The method of claim 18, wherein said adhesive layer is made of a short fiber-filled adhesive material.

23. The method of claim 17, wherein said adhesive layer is made of a flake-filled adhesive material.

24. The method of claim 18, wherein said adhesive layer is made of a flake-filled adhesive material.

25. The method of claim 17, wherein said adhesive layer is made of a particle-filled adhesive material.

26. The method of claim 18, wherein said adhesive layer is made of a particle-filled adhesive material.

27. The method of claim 15, wherein said bonding sheet is thermally conductive.

28. The method of claim 15, wherein said bonding sheet is electrically conductive.
